(19) United States
(12) Patent Application Publication
(10) Pub. No.: US 2016/0348423 A1
(43) Pub. Date: Dec. 1, 2016

(54) SLIDING SYSTEM

(71) Applicant: Ringo CRUYSBERGHS, Beringen (BE)

(72) Inventor: Ringo CRUYSBERGHS, Beringen (BE)

(21) Appl. No.: 15/117,239

(22) PCT Filed: Feb. 9, 2015
(86) PCT No.: PCT/IB2015/050967

§ 371 Date: Aug. 8, 2016

(30) Foreign Application Priority Data
Feb. 7, 2014 (BE) 2014/0085

(51) Int. Cl. E06B 7/23; E05D 15/06; E06B 3/46

(52) U.S. Cl. CPC E06B 7/23; E06B 3/4636; E06B 7/2316; E05D 15/063; E05D 15/0652; E05Y 2201/674; E05Y 2900/132

(57) ABSTRACT

The invention generally concerns an improved method for suspending and locking sliding means, which means it will no longer be necessary for an additional conduction structures at the bottom of the frame. By using the suspension system of this invention, it is no longer necessary to insert a bearing frame or framework in the window glass element, which makes it possible to realise seamless glass sections. Further, due to the absence of the additional conduction structures at the bottom of the frame element the indoor floors can pass into the outdoor floors without any barriers. The invention is based on using lifting and conduction structures as used in hermetic sliding doors, for opening and closing a window glass element where the edges of the window glass element have flexible sealing elements lying against the wall and the floor in the closed position of the window glass element.

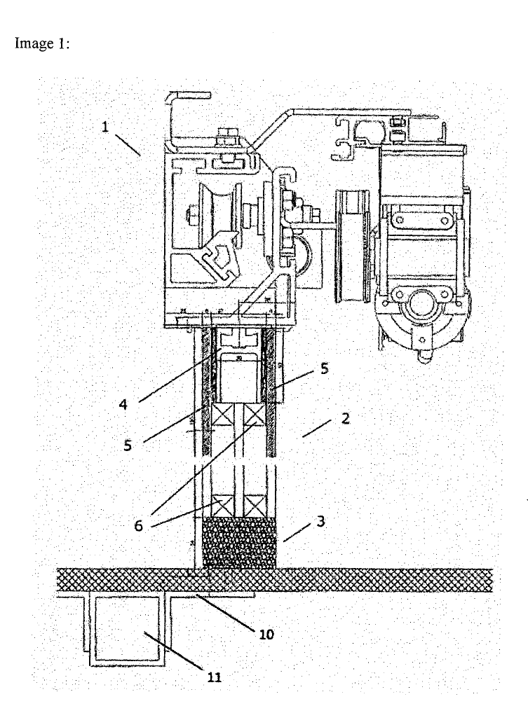

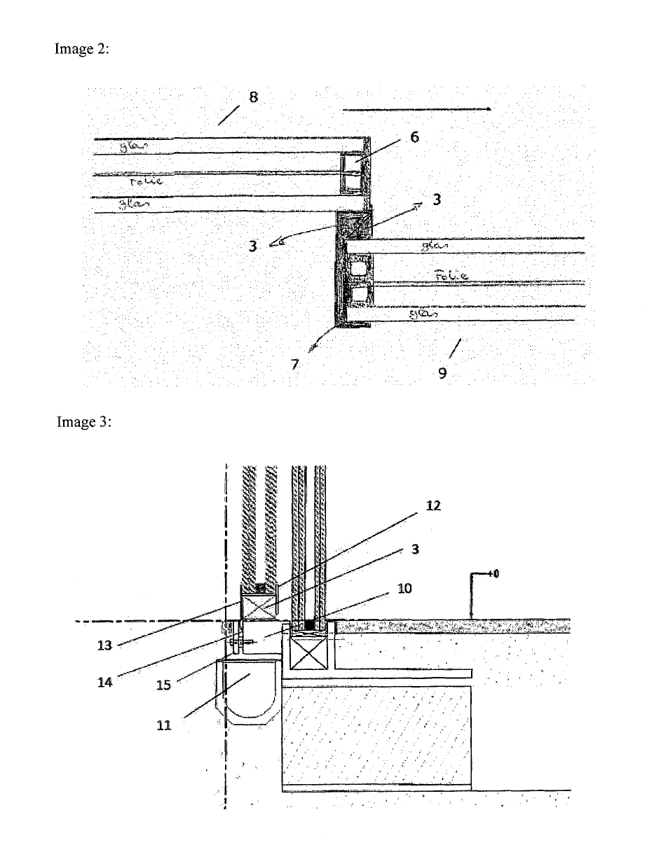

The invention generally concerns an improved method for suspending and locking sliding windows, which mean it will no longer be necessary to have an additional conduction structure at the bottom of the frame. By using the suspension system of this invention, it is no longer necessary to insert the glass element in a bearing frame or framework, which makes it possible to realise seamless glass sections. Further, due to the absence of the additional conduction structures at the bottom of the glass element the indoor floors can pass into the outdoor floors without any barriers. The invention is based on using lifting and conduction structures as used in hermetic sliding doors, for opening and closing a window glass element, where the edges of the window glass element have flexible sealing elements lying against the wall and the floor in the closed position of the window glass element. In addition to this, the sliding system also has draining elements that can be fully integrated in the floor and that do not cause visual barriers between the indoor and outdoor floors.

### BACKGROUND OF THE INVENTION

Sliding windows are often used in various types of buildings. It often concerns windows with a rather large surface, where the wings consist of rectangular bearing profiles, for example plastic and typically comprising double glass sheets. The wings are mounted in a rectangular bearing frame or framework, between a bottom and top ledge. The most frequently used form of execution has one fixed and one sliding wing. However, it is possible to install more than two wings in one framework, for example two fixed and two sliding wings. Two sliding wings can also be installed in one framework, which then moves relative to each other. When closed, the frame must in principle be water- and wind tight, although the absolute tightness could never be insured, which leads to the need for a combined sealing- and draining system.

If the sliding frame is closed, water can still enter from the outside via the seal between the glass panels and the surrounding bearing profiles. This water then ends in these bearing structures where the glass is secured. There must thus be a channel that runs around the outline of the profile in the bearing structure that allows the water to collect at the bottom of the wing and evacuate via a draining hole. A second way this water could possibly enter is via the seals between the wings. A system often has joining closing laths, fitted with seals across the full height or width of the sliding frame. However, to date there is no adequate solution for the proper draining of water that enters unavoidably in the bearing structure or framework via these seals. The existing facilities are normally not able to evacuate the water under high pressure, namely more than 300 Pa.

The purpose of this invention is to offer a solution for this problem by sharply simplifying the sliding frame constructions that are currently in use. By using a combination of a draining element with hoisting and conduction structures as used in hermetic doors it is possible with this invention to realise a sliding window that complies at all times with the aforementioned requirements with regard to water- and wind tightness, and this in the absence of a bearing profile that normally embraces the (glass) frame element. A conduction structure that can be mounted into the floor also ensures that the frame structure is laterally fixed with high outdoor pressure. An adjacent draining element will ensure the further water drainage.

### SUMMARY OF THE INVENTION

Without being restrictive, the following numbered embodiments give an overview of this invention.
1. The use of hoisting and conduction structures as used in hermetic doors for opening and closing a a window glass element where the edges of the window glass element have flexible sealing elements lying against the wall and/or adjacent frame structures and against the floor in the closed position, characterised in the absence of a bearing profile that embraces the window glass element, and characterised in that the flexible sealing elements which are lying in the closed state of the window glass element against the wall and/or adjacent framework structures, interlock with flexible sealing elements on the adjacent framework structures and/or walls.
2. The use according to claim 1, where the window glass element has one or multiple suspension elements.
3. The use according to claim 2, where the suspension element is integrated in the window glass element.
4. The use according to one of the previous claims where the vertical edges of the window glass element have U-shaped profiles.
5. The use according to claim 4, where the U-shaped structures comprise the flexible sealing elements which are lying in the closed state of the window glass element against the wall.
6. The use according to one of the previous claims where the flexible sealing element that presses against the floor in the closed state, is fitted immediately to the bottom of the framework structure.
7. The use according to claim 6, where the flexible sealing element that presses against the floor in the closed state, is fitted with a U-shaped structure to the bottom of the window glass element.
8. The use according to claim 6 or 7, where the flexible sealing element that presses against the floor in the closed state, has one or multiple conduction structures, which fit into an underlying conduction structure.
9. The use according to one of the previous claims where the hoist- and conduction structures are motorised.
10. A sliding frame that includes:
   hoisting and conduction structures as used in hermetic doors; and
   a window glass element of which the edges have flexible sealing elements that are lying, against the wall and/or adjacent framework structures and against the floor, in the closed state of the window glass element,
characterised in the absence of a bearing structure that embraces the window glass element and characterised in that the flexible sealing elements which are lying in the closed state of the window glass element against the wall and/or adjacent framework structures, interlock with flexible sealing elements on the adjacent framework structures and/or walls.
11. A sliding frame according to claim 9, where the frame structure has one or multiple suspension elements, preferably suspension elements that are integrated in the window glass element.
12. A sliding frame according to claims 9 and 10, where the vertical sides of the frame element have U-shaped profiles; in particular U-shaped profiles that comprise the flexible sealing elements that lie against the wall when the framework element is closed.

13. A sliding frame according to claims 9 to 11, where the flexible sealing element that presses against the floor in the closed state, is fitted immediately to the bottom of the window glass element.
14. A sliding frame according to claims 9 to 13, where the window glass element has one or multiple conduction structures at the bottom such as a pin or a plate shaped extension and an underlying conduction structure wherein the aforementioned conduction structures fit.
15. A sliding frame according to finding 14, where the conduction structure forms part of the U-shaped profile that includes the flexible sealing element that lies against the floor when the window glass element is closed.

### A BRIEF DESCRIPTION OF THE DRAWINGS

Image 1. A vertical cross section of a sliding frame (window) according to the finding comprising a window glass element 2 and a motorised hoist- and conduction structure as used in hermetic doors 1. The image also shows the glass sheets 5 with interim spacers 6 and the flexible sealing element 3 that is attached to the bottom of the framework structure. It is clear in this cross section that the frame structure is suspended from the conduction structures and that there is no bearing profile present that embraces the window glass element. In the displayed solution, the window glass element is suspended via a suspension element 4 that is attached between the outdoor glass panels. This figure also shows the underlying conduction structures 10 with adjacent draining element 11.

Image 2. A horizontal cross section of a sliding window according to the finding comprising a sliding window glass element 8 and a fixed window glass element 9, where both window elements have gripping flexible sealing elements 3, which form part of U-shaped profiles 7 placed across the edges of the window glass elements.

Image 3. A bottom, vertical cross section of a sliding window according to the finding that shows both the fixed and movable wing in a closed state. The flexible sealing elements 3 that grip into one another are not shown by this cross section. For the movable wing, profile 12 that comprises the flexible sealing element that presses against the floor in the closed state, is visible. Further, this cross section also shows another solution for the underlying conduction structures and the adjacent draining element. The U-shaped profile 12 is rather H shaped, which comprises the flexible sealing element that presses against the floor in the closed state, also has a conduction structure 13 on the outside. Especially a sheet shaped extension that is secured in a closed state in groove 14 of the underlying conduction structure 10. Based on this image it may be clear that the profile 12 that comprises the flexible sealing element that presses against the floor in the closed state, is both U-shaped and H-shaped, where the face on the outside optionally has one or more conduction structures 13.

### DESCRIPTION OF THE INVENTION

This invention is based on using hoist and conduction elements as used in hermetic sliding doors, for opening and closing a window structure.

The window glass element as used herein refers to the glass section that is typically used in a window framework structure, and which at least consists of two glass sheets that are connected to one another at a specific distance from one another, so that an insulated area is created between the glass panels or cavity. The window glass element could also be set-up in triplicate, with two air layers between the three glass panels. The spacer in the cavity of the window glass elements is mostly a hollow metal spacer filled with a drying agent that ensures the absorption of the vapour from the cavity. The glass panels and spacer are secured towards each other with a double sealing kit. The inner sealing kit ensures the gluing of the spacer with the glass panels and it is finished with a UV resistant material such as butyl. The outer sealing kit must ensure that the cavity between the glass panels is watertight. This normally consists of polysulphide or polyurethane, but the disadvantage of these materials is that they are not UV resistant and must thus be protected from direct sunlight. Alternative UV resistant kit materials could naturally also be used to make the frame structures watertight.

Hoisting and conduction structures as used in hermetic doors will ensure that the door, when it is locked, moves to the wall and the floor, in such a manner that the door, after being locked, is lying agains the wall and the floor. This is achieved via conduction structures where the door is suspended from a roller body with cavities so that the door, when locked, move to the wall and the floor. In order to realise an hermetical closure of the door, it has flexible sealing elements along the edges that presses against the floor and the wall when locked. Such sliding doors and accompanying hoist- and conduction structures are, for example, those from the American patent U.S. Pat. No. 4,404,770, and the Belgian Patent BE1002467. In a special form, the hoist- and conduction structures that are used with these hermetic doors are motorised and possibly automated as, for example, described in the European patent application EP1203863.

It is common practice when using such hermetic sliding doors that the locking follows from the door pressing and/or pushing against the floor and the wall. When the door panel is slightly bent, it would thus be difficult to achieve proper locking. For this reason, the aforementioned sliding doors must typically by heavy, or have extra reinforcement to achieve sufficient stiffness of the door element. Thus, to the extent that such hermetical sliding doors have a window structure, this is either integrated in the door panel manufactured from an adequately rigid material such as metal, or it is suspended in a rectangular bearing profile. The latter has sufficient rigidity and strength to carry the framework element without distortion.

In this finding, it was also established that it is possible to use a window glass element per se in the aforementioned hoisting and conduction structures used with hermetic doors for opening and closing the relevant window structure, where this window glass element has flexible sealing elements. When closing the window glass element, just like with hermetical doors, the flexible sealing elements will be pressed against the wall and the floor. In view of the aforementioned constructions that have to ensure that the door elements have sufficient strength and rigidity, it was, in our opinion not obvious to use this for a window glass element as such, i.e. without a bearing support. As everyone knows, mechanical forces that affect glass lead to tension, which could result in glass breakage. In this, the mechanical forces follows from pressing the window glass element against the wall and the floor. However, it did seem possible to use a window glass element an sich via the aforementioned hoisting and conduction structures insofar as the window glass elements have flexible sealing elements on the edges, for example manufactured from silicon, rubbers or silicon rubbers. The flexible sealing element at the bottom of the framework element and that presses against the floor when locked must preferably have a rubber with a high tensile strength, elasticity, tearing strength, high tear resistance, a good memory and a low compression network, for example such as natural rubber, cis polyisoprene (IR) rubber, Butadiene Rubber (Poly butadiene, BR), Poly chloroprene (Poly chloroprene, CR) rubber, Poly acrylate elastomer, Acryl rubber (Alkyl Acrylic copolymer, ACM), and the like. In a special embodiment, the flexible sealing elements, and in particular the sealing element at the bottom of the framework structure, is an EPDM polymer. In an embodiment of this invention, the flexible sealing element that presses against the floor in the closed state, is attached directly to the bottom of the window glass element.

Separate from the aforementioned problem, the use of the known hoist and conduction structures wherein the window glass element is suspended also sets a challenge for guaranteeing the water- and wind tightness in a closed state. As indicated before, windows on the outside may be exposed to high pressure (wind pressure). For this purpose, a classic window structure includes in a frame structure that prevent, due to upstanding edges, that the window glass element is pressed from the profile. The frame structure of the profile will also handle the draining along the window glass element. When using the aforementioned hoist and conduction structures, the water tightness will in the first instance follow from the selection of the aforementioned flexible sealing elements. Due to their low compression set, these sealing elements press tightly against the adjacent framework structure and/or walls and one achieves a seal that is able to resist the normal weather conditions to realise the wind- and water tightness of the sliding frame. Characteristically to this, and as shown in image 2, the vertical edges of the adjacent framework structures and/or walls also have flexible sealing elements for this purpose; in particular flexible sealing elements that grip into one another with the vertical sealing elements of the sliding wing. Since the flexible sealing elements grip into one another, the seals maintain contact when the framework structure is moved inwards and the seals are opened slightly and the wind and water tightness of the framework structure will be maintained. These flexible sealing elements should preferably have the displayed triangular cross section. In the displayed method, these flexible sealing elements are attached to the edges of the framework structure. As such, when the window structure is closed, the hooking operation also creates a lateral resistance for the window structure.

In this further form, the pressure may even be higher before the seals would fail and are effectively pressed open. Thus, in a first objective when using hoisting and conduction structures, the window glass element is characterised in the absence of a supporting frame structure, where the edges of the window glass element have flexible sealing elements that, when the window glass element is closed press against the wall and the floor, and in that, the flexible sealing elements of the window glass element that press against the wall when the framework structure is closed, grip onto each other with flexible sealing elements on the adjacent framework structures and/or walls; in particular with flexible sealing elements on the adjacent vertical framework structures and/or walls.

However, at high wind speeds it cannot be excluded that the window glass element, which in the end only stands under its weight and suspended in the hoist- and conduction structures on the floor, will be pressed inside by the wind pressure. For this purpose according to another method, the framework structure will have one or more conduction structures at the bottom, such as a pin or a plate shaped extension that laterally secures the framework structure to the floor within an underlying conduction structure. In such an embodiment, this underlying conduction structure will preferably work with an adjacent draining element for transporting water that runs along the framework structure when it rains. In reference to image 3, the conduction structures will have a draining channel 14 that also serves as conducting channel for conducting elements 13 that are at the bottom of the window glass element. In the displayed embodiment, the conduction/draining channel spreads along the full length of the window glass element. To simplify the installation, the underlying conduction structure has a removable front plate 15 with adjustable groove width. The conduction/draining channel leads directly to an underlying/adjacent (image 1) draining element (gutter).

Thus, in a specific method according to this invention, it concerns a window frame, said window frame comprising; hoisting and conduction structure as used in hermetic doors; a window glass element of which the edges only have flexible sealing elements lying against the wall and the floor in the closed position of the window element, and characterised in that;
the flexible sealing elements of the window glass element that rests against the wall and/or adjacent framework structure when closed, grip onto another with flexible sealing elements on the adjacent framework structures and/or walls; in that
the window glass element at the bottom comprises one or multiple conduction elements, such as a pin or a plate shaped extension and in the presence of an underlying conduction structure wherein the aforementioned conduction elements fit.

As stated above, the framework structure is suspended in the conduction structure by one or multiple roller bodies with accompanying suspension elements. The technician is fully up to date with the resources on hand (suspension elements) to hang glass panels on the aforementioned roller bodies.

However, in a special execution method of this invention one or multiple suspension elements are integrated in the window glass element. As shown in image 1, this suspension element can in accordance with the spacer in the glass cavity, be stuck between the outside glass panels. A similar sealing kit as the one used for gluing the spacer in the cavity, can be used for this. In a specific method, the suspension element consists of a metal structure that is stuck across the full length of the window glass element between the outside glass panels. This structure particularly has a cross section as shown in image 1.

As indicated above, the outside sealing kit is often manufactured from a non UV resistant material such as polysulphide or polyurethane. When using these frame structures, the outdoor sealing kit is recommended to protect it against exposure to sunlight. As such, in an embodiment of the current invention, the edges of the frame element have U-shaped profiles, for example from plastic or metal, which are mounted to the edges. This U-shaped profile thus only serves to protect the outdoor sealing kit and/or the cutting edges of the glass panels. A widow glass element comprising such U shaped profiles has no supporting capacity and is thus clearly different from the bearing profiles that have sufficient rigidity and strength to carry the window glass element without distortion. The sealing elements can be applied to these U-shaped profiles but in a special embodiment the sealing elements form part of the U-shaped profiles. This can, for example be seen in the cross section of the vertical profiles in image 2, where the movable window glass element does not press against a wall, but against another frame structure. This configuration appears, for example, with a sliding frame with multiple wings. In image 2 it concretely concerns a sliding frame with two wings where the left wing moves in the specified direction before the right wing. In the displayed configuration, the vertical sealing elements of the sliding wing will not only press against the fixed wing when locked, but the latter also has vertical sealing elements that grip into one another with the vertical sealing elements of the sliding wing and thus guarantee the water tightness and wind tightness. In a specific embodiment, the U-shaped profile that comprises the flexible sealing element which press against the floor when locked, will have conduction elements. In particular, conduction elements in the form of one or multiple pins or a panel shaped extension on the outside of the U-shaped profile.

The purpose of this invention is also to include a sliding window where this sliding window; includes a hoisting and conduction structure as used in hermetic doors; and

a window glass element of which the edges only have flexible sealing elements lying against the wall and the floor characterised in the absence of a bearing structure that embraces the window glass element, and in that the vertical edges of the adjacent framework element and/or walls also have flexible sealing elements that grip onto one another with the flexible sealing elements of the framework structure (supra). Preferably the flexible sealing elements that lie against the floor when closed must also have conduction elements that grab into an underlying conduction structure.

As shown in image 3, the top of this underlying conduction structure is on the same level as the floor. As such, and in contrast to the existing sliding windows with a support structure, there is no longer any level difference and realizing a level floor when the window is open. Only a narrow groove 14 in the conduction structure provides a visual transition between the indoor and outdoor floor. As already indicated before, this groove must serve as a spacer wherein the conduction structure moves after locking to laterally fix the window glass element. In addition to this, this groove 14 also serves as draining channel to an underlying gutter 11. The sliding window thus at least includes one window glass element, but could obviously consist of multiple window glass elements such as a sliding window with a fixed and a sliding wing; a sliding window with one fixed and two sliding wings; a sliding window with two fixed and one sliding window; in every imaginable combination. In such sliding window with multiple window glass elements, the edges of the sliding window structure must have flexible sealing elements that are lying in the closed state of the window structure, against the wall and/or the adjacent framework structures and against the floor. In a special embodiment, the vertical edges of the adjacent framework structures and/or walls must also have flexible sealing elements for this purpose; in particular flexible sealing elements that interlock with the vertical sealing elements of the sliding wing.

The invention also concerns a sliding window that concerns: hoisting and conduction structure as used in hermetic doors;

one or multiple sliding window elements; and

one or multiple fixed window elements; characterised in that the edges of the sliding window elements have flexible sealing elements that upon closure rests against the wall and/or adjacent framework structures and against the floor. In a special form, the vertical edges of the adjacent framework structures and/or walls must also have flexible sealing elements for this purpose; in particular flexible sealing elements that interlock with the vertical sealing elements of the sliding window.

In each of the previous execution methods, the sliding window glass elements are suspended in the hoist- and conduction structure as described in detail before. These window glass elements then also have one or multiple suspension elements (supra), that are preferably integrated in the window glass element (supra).

These sliding windows also include each of the previous options with regard to the used flexible sealing elements and U-shapes.

The only purpose of this description is to further explain the general principles of the invention, as such, nothing in this description may be interpreted as being a restriction in the field of applying the invention or of the patent rights that are requested in the following claims.

1. A method for opening and closing a window glass element wherein the edges of the window glass element have flexible sealing elements lying against the wall and/or adjacent frame structures and against the floor in the closed state, the method comprising:
sliding the window glass element via hoisting and conduction structures, wherein:
a bearing profile that embraces the window glass element is absent, and
the flexible sealing elements which are lying in the closed state of the window glass element against the wall and/or adjacent framework structures interlock with flexible sealing elements on the adjacent framework structures and/or walls.

2. The method according to claim 1, wherein the window glass element has one or multiple suspension elements.

3. The method according to claim 2, wherein the one or multiple suspension elements is integrated in the window glass element.

4. The method according to claim 1, wherein the vertical edges of the window glass element have U-shaped profiles.

5. The method according to claim 4, wherein the U-shaped profiles comprise the flexible sealing elements which are lying in the closed state of the window glass element against the wall.

6. The method according to claim 1, wherein the flexible sealing elements that press against the floor in the closed state are fitted immediately to the bottom of the framework structures.

7. The method according to claim 6, wherein the flexible sealing elements that press against the floor in the closed state are fitted with a U-shaped structure to the bottom of the window glass element.

8. The method according to claim 6, wherein the flexible sealing elements that press against the floor in the closed state have one or multiple conduction structures which fit into an underlying conduction structure.

9. The method according to claim 1, wherein the hoisting and conduction structures are motorised.

10. A sliding frame that includes:
hoisting and conduction structures as used in hermetic doors; and
a window glass element of which the edges have flexible sealing elements that are lying against the wall and/or adjacent framework structures and against the floor in the closed state of the window glass element, wherein:
a bearing structure that embraces the window glass element is absent, and
the flexible sealing elements which are lying in the closed state of the window glass element against the wall and/or adjacent framework structures interlock with flexible sealing elements on the adjacent framework structures and/or walls.

11. The sliding frame according to claim 10, wherein the framework structures have one or multiple suspension elements.

12. The sliding frame according to claim 10, wherein the vertical sides of the frame element have U-shaped profiles.

13. The sliding frame according to claim 10, wherein the flexible sealing element that presses against the floor in the closed state is fitted immediately to the bottom of the window glass element.

14. The sliding frame according to claim 10, wherein the window glass element has one or multiple conduction structures at the bottom and an underlying conduction structure wherein the aforementioned conduction structures fit.

15. The sliding frame according to claim 14, wherein the one or multiple conduction structures form part of a U-shaped profile that includes the flexible sealing element that lies against the floor when the window glass element is closed.
